(19) United States
(12) Patent Application Publication
(10) Pub. No.: US 2020/0318834 A1
(43) Pub. Date: Oct. 8, 2020

(54) MOISTURE CONVECTION FOR MICROWAVE OVEN

(71) Applicant: WHIRLPOOL CORPORATION, BENTON HARBOR, MI (US)

(72) Inventors: Vince Huang, Shenzhen (CN); Dick Ge, Benton Harbor, MI (US); Tracy Yu, Benton Harbor, MI (US)

(73) Assignee: WHIRLPOOL CORPORATION, BENTON HARBOR, MI (US)

(21) Appl. No.: 16/311,069

(22) PCT Filed: Dec. 6, 2016
(86) PCT No.: PCT/CN2016/108677

§ 371 Date: Dec. 18, 2018

(51) Int. Cl. F24C 7/02; F24C 15/32

(52) U.S. Cl. CPC F24C 7/02; H05B 6/6479; F24C 15/327

(57) ABSTRACT

A convection microwave oven (2) includes a moisture convection system (10) for providing moisture into the cooking cavity (6) of the microwave oven (2) to help keep heated and/or cooked items moist. The moisture convection system (10) includes a removable water tank (40) that provides water for the moisture convection system (10). The moisture convection system (10) includes a pump (42) that pumps water to a nozzle (46) that sprays water onto the convection heater (24) of the microwave oven (2) to create evaporate (E) that is moved into the cooking cavity (6) of the microwave oven (2) by the convection fan wheel (22).

### CROSS REFERENCE TO FOREIGN PRIORITY DOCUMENT

The present application claims the benefit under 35 U.S.C. §§ 119, 365, and/or 386 of International Application No. PCT/CN2016/108677 filed Dec. 6, 2016.

### BACKGROUND

Generally, a microwave oven is an electrically powered apparatus which uses high frequency electromagnetic waves to heat and/or cook an item within a cavity of the microwave oven. The high frequency electromagnetic waves—microwaves—are generally generated from a magnetron or microwave generator disposed adjacent to the cooking cavity. Microwave ovens can also have a convection cooking feature which uses a heater and fan to heat the cooking cavity of the microwave oven. While microwave ovens are useful to heat and/or cook an item within the cooking cavity, the convection system inside the microwave oven generates hot air to heat the item, which can make the item very dry. Thus, it is desirable to have a microwave oven that has the ability to provide moisture into the cooking cavity to help keep the item moist.

### SUMMARY OF THE INVENTION

One aspect of the present invention is a microwave oven with a housing, a cooking cavity, a convection heater, and a moisture convection system. The moisture convection system includes a water tank and a pump connected to the water tank to pump water through a tube to a nozzle where the water can be sprayed onto the convection heater to create evaporate for the cooking cavity.

Another aspect of the present invention is a moisture convection system for a convection microwave oven. The system includes a tank, a pump connected to the tank, and a nozzle connected to the pump. The nozzle is configured to spray water onto the convection heater of the microwave oven to create evaporate for the cooking cavity of the microwave oven.

Another aspect of the present invention is a method of creating evaporate for a cooking cavity of a microwave. The method includes coupling a water tank with the microwave oven and coupling a pump to the water tank. A nozzle is then coupled to the pump and positioned so that water pumped through the nozzle contacts the convection heater of the microwave oven to create the evaporate for the cooking cavity of the microwave oven.

These and other features, advantages, and objects of the present invention will be further understood and appreciated by those skilled in the art upon studying the following specification, claims, and appended drawings.

### BRIEF DESCRIPTION OF THE DRAWINGS

In the drawings:

FIG. 1 is a front perspective view of a microwave oven according to an embodiment of the present concept;

FIG. 2 is a front perspective view of the convection system assembly inside the microwave oven;

FIG. 3 is an exploded view of the convection system assembly;

FIG. 4 is a cross-sectional view of a nozzle in accordance with an embodiment of the present invention;

FIG. 5 is a perspective view of water sprayed from a nozzle in accordance with an embodiment of the present invention;

FIG. 6 is an exploded view of the convection system assembly including a nozzle with a water line for spraying water on the heater;

FIG. 7 is a side perspective view of a spray nozzle and flow meter for a microwave oven of the present invention with part of the housing removed;

FIG. 8 is a top view of the valve and pump used in an embodiment of the present invention with part of the microwave housing removed;

FIG. 9 is a cross-sectional view illustrating the fan wheel motor and heater with lines showing the evaporate flow within the cooking cavity of the microwave oven;

FIG. 10 is a perspective view of the moisture convection system with the lines, the pump, and the spray nozzle going onto the heating element;

FIG. 11 is a schematic illustrating the moisture convection system; and

FIG. 12 is a front perspective view of a microwave oven with the water tank removed, in accordance with an embodiment of the present invention.

### DETAILED DESCRIPTION OF THE PREFERRED EMBODIMENTS

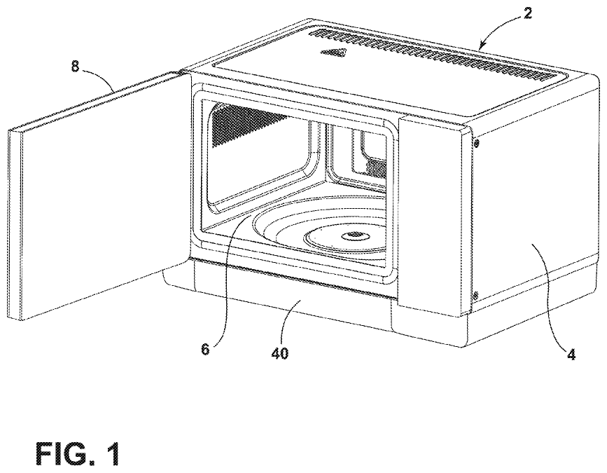

As referenced in the figures, the same reference numerals may be used herein to refer to the same parameters and components or their similar modifications and alternatives. For purposes of description herein, the terms “upper,” “lower,” “right,” “left,” “rear,” “front,” “vertical,” “horizontal,” and derivatives thereof shall relate to the present disclosure as oriented in FIG. 1. However, it is to be understood that the present disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. The drawings referenced herein are schematic and associated views thereof are not necessarily drawn to scale.

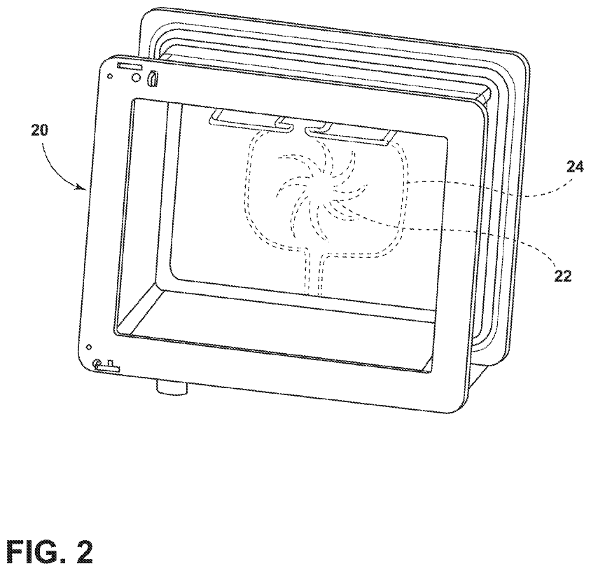

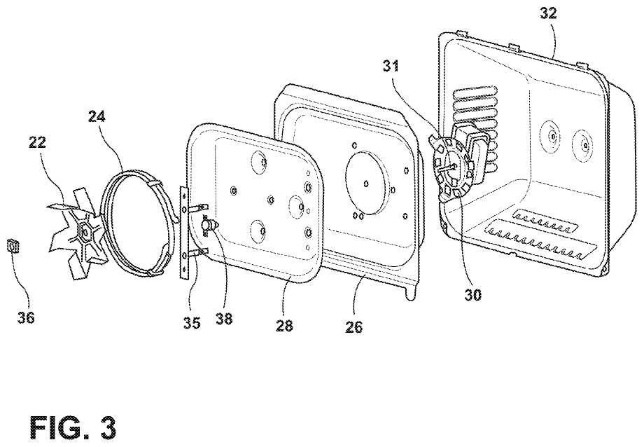

With reference to the drawings, a microwave oven 2 includes a housing 4 with a cooking cavity 6. The microwave oven 2 includes a convection cooking feature utilizing a convection assembly 20. As illustrated in FIG. 3, the convection assembly 20 can include a housing 32 that connects the convection assembly 20 to the microwave oven 2. The convection assembly 20 includes a fan wheel 22 that is powered by a motor 30. The fan wheel 22 can be attached to the motor 30 using a fastener 36 and connector 38. In addition, the convection assembly 20 can include a plate 26 and a shield 28 for containing the heat generated by the heater 24. The plate 26 and the shield 28 can have openings through which the post 31 of the motor 30 extends for connecting to the fan wheel 22. The heater 24 can be connected to convection assembly 20 through a heater connector, which can include post 35 that can extend through holes in the shield 28 and the plate 26 to a source for providing electricity and/or heat to the heater 24. An example of the fully assembled convection assembly 20 is shown in FIG. 2 with the fan wheel 22 and the heater 24 shown in dashed lines.

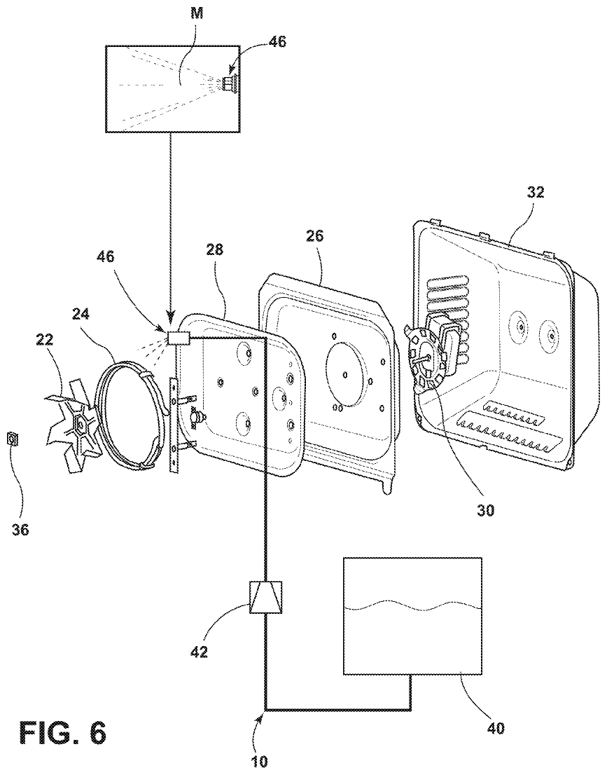

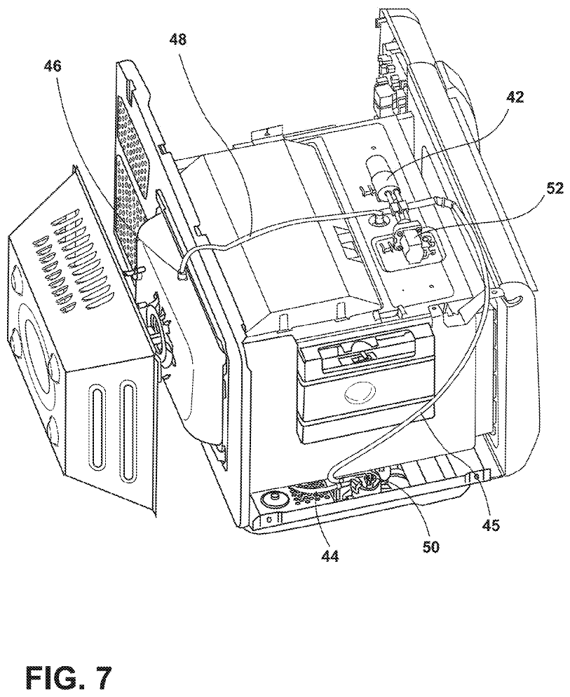

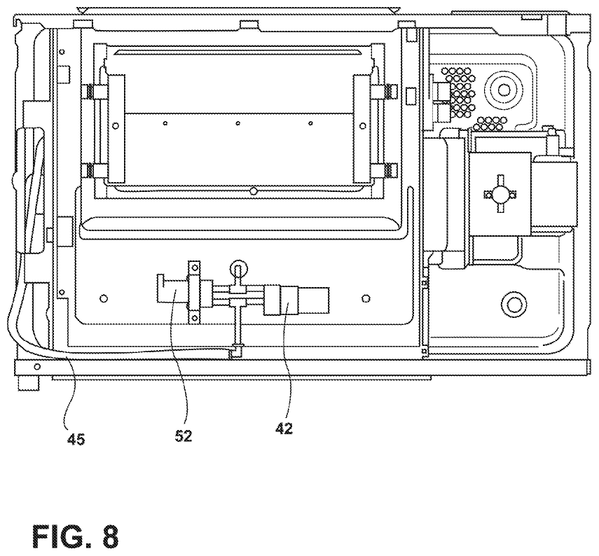

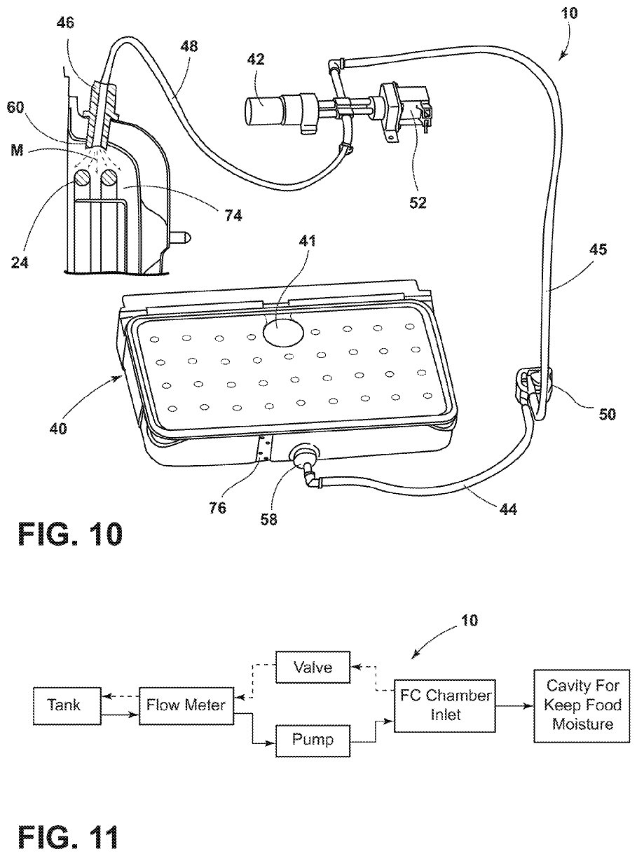

The moisture convection system 10 of the present invention is illustrated in FIGS. 6-12. As illustrated in FIG. 6, the moisture convection system 10 includes a water tank 40, a pump 42, and a nozzle 46. Water in the water tank 40 is moved through the pump 42 to the nozzle 46 and sprayed as a mist M onto the heater 24. As illustrated in FIG. 10, there is an inlet 60 into the fan convection chamber 74 which permits the nozzle 46 to be positioned to spray mist M onto the heater 24.

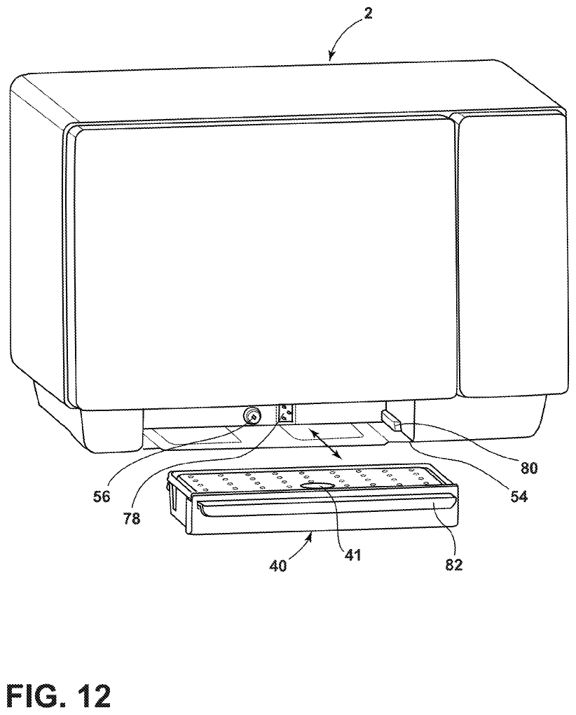

The water tank 40 of the moisture convection system 10 is best illustrated in FIGS. 10-12. The water tank 40 can include a fill port 41 as well as a docking mechanism 76 which mates with the corresponding structure 78 within the water tank compartment 54 of the microwave oven 2. This docking mechanism permits confirmation that the water tank 40 is fully and correctly positioned within the water tank compartment 54. This feature ensures that the water tank 40 is properly seated within the microwave oven 2 to prevent water leakage. A seal can be used to seal the connection between the water tank 40 and the water tank compartment 54. This could include a seal where the water flows from the water tank 40 to the connector 58. The water tank compartment 54 can include mechanical structures 80 that correspond to structures (not shown) on the water tank 40 to align the water tank 40 as it is inserted into the water tank compartment 54, as shown by the arrows in FIG. 12. The water tank 40 can also include a handle 82 to assist in the installation and removal of the water tank 40 from the microwave oven 2. A port 56 is located within the water tank compartment 54 to mate with an associated opening on the water tank 40.

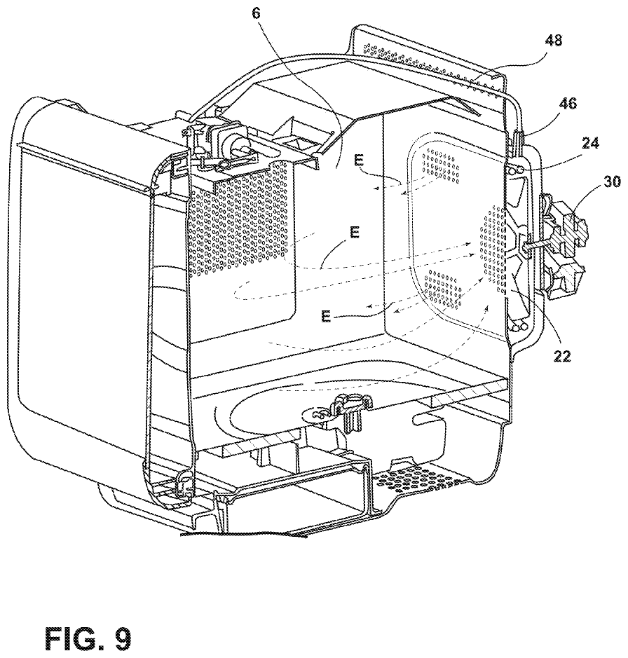

As shown in FIG. 10, the moisture convection system 10 also includes a water line 44 that extends from a connector 58 to a flow meter 50. A water line 45 then extends from the flow meter 50 to the pump 42, which is also connected to a valve 52. A water line 48 extends from the pump 42 to the nozzle 46, which is connected to the microwave oven 2. The nozzle 46 extends through an inlet 60 and is positioned near the heater 24. As illustrated in FIG. 11, the flow meter determines when water should be pumped to the fan convection chamber 74 and the valve 52 can open and close the path of water to be pumped to the nozzle 46. When the water is pumped to the fan convection chamber 74, the water is turned into mist M, as illustrated in FIG. 5. The mist M, as illustrated in FIGS. 6 and 10, is then sprayed onto the heater 24 to create evaporate E that is circulated via the fan wheel 22 into and around the cooking cavity 6, as illustrated in FIG. 9. The nozzle 46 can be adhered to, fastened to, or otherwise coupled to the inlet 60. The evaporate E that is in the cooking cavity 6 permits food to stay moist when the convection feature is used in the microwave oven 2.

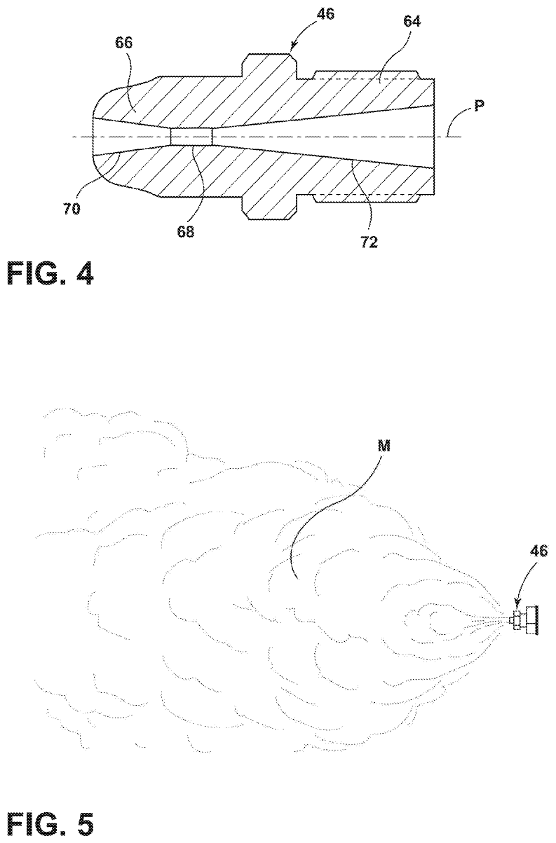

Nozzle 46, as shown in FIG. 4, has a tip 66 and an end 64 that is attached to the water line. The path P of the water can be through a tapered section 72 to a narrow section 68 to concentrate the water before opening to another tapered section 70 to create the mist M, as shown in FIG. 5.

It will be understood by one having ordinary skill in the art that construction of the described device and other components is not limited to any specific material. Other exemplary embodiments of the device disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above is merely for illustrative purposes and not intended to limit the scope of the device, which is defined by the following claims as interpreted according to the principles of patent law, including the Doctrine of Equivalents.

1. A microwave oven, comprising:
a housing;
a cooking cavity;
a convection heater; and
a moisture convection system comprising:
a water tank;
a pump connected said water tank; and
a nozzle connected to said pump, wherein said pump is configured to pump water through said nozzle directly onto the convection heater to create evaporate for said cooking cavity.

2. The microwave oven of claim 1, further comprising a flow meter connected between the water tank and the pump.

3. The microwave oven of claim 2, further comprising a valve which is controlled by the flow meter to control the flow of pumped water to said nozzle.

4. The microwave oven of claim 1, wherein said convection heater includes a coiled heating element with a generally unilateral orientation.

5. The microwave oven of claim 1, wherein said water tank is removable from the microwave oven.

6. The microwave oven of claim 1, wherein said nozzle includes at least one tapered portion.

7. The microwave oven of claim 1, wherein said water tank includes a docking mechanism that mates with a corresponding structure on the microwave oven.

8. A moisture convection system for creating evaporate for a convection microwave oven, comprising:
a tank;
a pump connected to said tank;
a nozzle connection to said pump; and
wherein said nozzle is configured to spray water directly onto the convection heater of the microwave oven to create evaporate for the cooking cavity of the microwave oven.

9. The moisture convection system of claim 8, further comprising a flow meter connected between the water tank and the pump.

10. The moisture convection system of claim 9, further comprising a valve which is controlled by the flow meter to control the flow of the pump water to said nozzle.

11. The moisture convection system of claim 8, wherein said convection heater includes a coiled heating element with a generally vertical orientation.

12. The moisture convection system of claim 8, wherein said water tank is removable from the microwave oven.

13. The moisture convection system of claim 8, wherein said nozzle includes at least one tapered portion.

14. The moisture convection system of claim 8, wherein said water tank includes a docking mechanism that mates with a corresponding structure on the microwave oven.

15. The moisture convection system of claim 8, further comprising a seal between said water tank and said microwave oven.

16. A method for creating evaporate for a microwave oven cooking cavity, including:
coupling a water tank to the microwave oven;
coupling a pump to said water tank;
coupling a nozzle to said pump in a position to spray water directly onto the convection heater of said microwave oven to create evaporate for the cooking cavity.

17. The method for creating evaporate for a microwave oven cooking cavity of claim 16, further comprising coupling a flow meter between the water tank and the pump.

18. The method for creating evaporate for a microwave oven cooking cavity of claim 17, further including coupling a valve, which is controlled by the flow meter, to the pump to control the flow of pumped water to said nozzle.

19. The method for creating evaporate for a microwave oven cooking cavity of claim 16, wherein the connection between the water tank and the nozzle include water lines.

20. The method for creating evaporate for a microwave oven cooking cavity of claim 16, wherein the water tank is removably coupled to said microwave oven.
